(19) United States
(12) Patent Application Publication
(10) Pub. No.: US 2007/0191062 A1
(43) Pub. Date: Aug. 16, 2007

(54) Apparatus and method for transmitting and receiving signals in a wireless communication system

(75) Inventors: Yong-Seok Kim, Suwon-si (KR); Young-Hoon Kwon, Seongnam-si (KR); Soon-Young Yoon, Seoul (KR); Sung-Soo Hwang, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/649,734

(22) Filed: Jan. 4, 2007

(30) Foreign Application Priority Data
Jan. 4, 2006 (KR) 1112/2006

(51) Int. Cl. H04B 1/38

(52) U.S. Cl. 455/561

(57) ABSTRACT

An apparatus and method for transmitting and receiving signals in a wireless communication system with at least two antenna are provided, in which a first antenna transmits a transmission signal, a second antenna receives a reception signal, a transmitter sends the transmission signal through the first antenna and a receiver receives the reception signal through the second antenna.

### PRIORITY

This application claims the benefit under 35 U.S.C. § 119(a) of a Korean Patent Application filed in the Korean Intellectual Property Office on Jan. 4, 2006 and assigned Serial No. 2006-1112, the contents of which are incorporated herein by reference.

### BACKGROUND OF THE INVENTION

1. Field of the Invention

The present invention generally relates to a wireless communication system, and more particularly, to an apparatus and method for transmitting and receiving signals by spatial division in a wireless communication system.

2. Description of the Related Art

Typically, wireless communication systems operate in duplexing schemes such as Frequency Division Duplexing (FDD) and Time Division Duplexing (TDD) schemes. Transmission and reception are performed at the same time but at different frequency bands in FDD, whereas transmission and reception are performed at the same frequency band but at different time intervals in TDD.

In FDD, transmission and reception take place in different spectrum bands. An FDD-based apparatus will be described below with reference to FIG. 1.

FIG. 1 illustrates the configuration of an FDD-based apparatus in a conventional wireless communication system. The following description is made with the appreciation that the FDD-based apparatus is a Base Station (BS) that provides services to a plurality of Mobile Stations (MSs), by way of example.

Referring to FIG. 1, a BS 100 includes a transmitter 101, a receiver 103, a duplexer 105 and an antenna 107.

The transmitter 101 processes a transmission signal inside the BS 100, and the receiver 103 processes a signal received from outside the BS 100. The duplexer 105 is used to share the single antenna 107 between a transmission frequency and a reception frequency. Thus, the duplexer 105 distinguishes the transmitter 101 from the receiver 103, sharing the single antenna 107 between the transmitter 101 and the receiver 103 and.

In TDD, transmission and reception take place at different times. Hence, a single antenna suffices for signal transmission and reception in each of a transmitter and a receiver. That is, due to the use of the same frequency for transmission and reception in TDD, a transmission time period and a reception time period are preset and signal transmission and reception are carried out during the transmission time period and the reception time period, respectively. A TDD based apparatus will be described below with reference to FIG. 2.

FIG. 2 illustrates the configuration of a TDD-based apparatus in the conventional wireless communication system. The following description is made with the appreciation that the TDD-based apparatus is a BS that provides services to a plurality of MSs, by way of example.

Referring to FIG. 2, a BS 200 includes a transmitter 201, a receiver 203, a switch 205 and an antenna 207.

The transmitter 201 processes a transmission signal inside the BS 200, and the receiver 203 processes a signal received from outside the BS 200. The switch 205 is used to share the single antenna 207 between the transmitter 201 and the receiver 203.

The switch 205 switches a signal transmitted through the antenna 207 from the transmitter 201 for a transmission time period, and switches a signal received through the antenna 207 to the receiver 203 for a reception time period.

The features of TDD and FDD are listed in Table 1 below.

TABLE 1

| | TDD | FDD |
|---|---|---|
| Scheduling complexity | High | Low |
| Frequency use efficiency | High | Low |
| Guard band | Unnecessary | Necessary |
| Guard time | Necessary | Unnecessary |
| Asymmetrical traffic | adaptable | unadaptable |
| adaptability | | |
| Link budget | 3 dB decrease, | 3 dB increase, |
| | compared to FDD | compared to TDD |
| Channel reciprocity | Available | unavailable |
| Uplink-downlink | interference | No interference |
| interference | | |

As noted from Table 1, despite high scheduling complexity relative to FDD, TDD is the more efficient duplexing scheme in terms of frequency use efficiency and thus resource efficiency.

Due to the use of one frequency band for transmission and reception, compared to FDD that allocates different frequencies for transmission and reception, TDD requires no guard band. Yet, TDD requires as long a guard period as a Round Trip Delay (RTD) or switching delay involved in transmission and reception.

There is an about 3-dB link budget decrease in TDD, relative to FDD. As TDD uses the same frequency in signal transmission and reception, it is feasible for spatial signal processing for channel reciprocity. Hence, channel reciprocity can be exploited in TDD. On the contrary, channel reciprocity is impossible in FDD.

To cancel interference between signal transmission and reception, TDD requires the same frame start time and the same uplink-downlink ratio between cells. However, FDD experiences no interference between transmission and reception.

Thus, TDD suffers from time resource dissipation and FDD suffers from frequency resource dissipation. Also, TDD and FDD have the drawbacks illustrated in Table 1.

### SUMMARY OF THE INVENTION

The present invention is provided to address at least the problems and/or disadvantages and to provide at least the advantages described below.

Accordingly, the present invention provides an apparatus and method for transmitting and receiving signals without dissipating time and frequency resources in a wireless communication system.

The present invention provides an apparatus and method for transmitting and receiving signals, which overcome the drawbacks of TDD and FDD in a wireless communication system.

In accordance with the present invention, there is provided an apparatus for transmitting and receiving signals in a wireless communication system having at least two antennas, in which a first antenna transmits a transmission signal, a second antenna receives a reception signal, a transmitter transmits the transmission signal through the first antenna, and a receiver receives the reception signal through the second antenna.

In accordance with the present invention, there is provided a method of transmitting and receiving signals in a wireless communication system having at least two antennas, in which a first signal is transmitted through a first antenna dedicated to signal transmission by a transceiver, and a second signal is received through a second antenna dedicated to signal reception by the transceiver.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates the configuration of an FDD-based apparatus in a conventional wireless communication system;

FIG. 2 illustrates the configuration of a TDD-based apparatus in the conventional wireless communication system;

FIGS. 3A, 3B and 3C illustrate FDD-based resource allocation, TDD-based resource allocation, and Spatial Division Duplexing (SDD)-based resource allocation according to the present invention, respectively;

FIG. 4 illustrates the structure of an SDD-based BS in a wireless communication system according to the present invention;

FIG. 5 illustrates the structure of an SDD-based BS according to the present invention;

FIG. 6 illustrates an antenna configuration for SDD implementation in the wireless communication system according to a first embodiment of the present invention;

FIG. 7 illustrates an antenna configuration for SDD implementation in the wireless communication system according to a second embodiment of the present invention;

FIG. 8 illustrates an antenna configuration for SDD implementation in the wireless communication system according to a third embodiment of the present invention; and

FIG. 9 illustrates signal transmission and reception between a BS and TDD-based MSs according to the present invention.

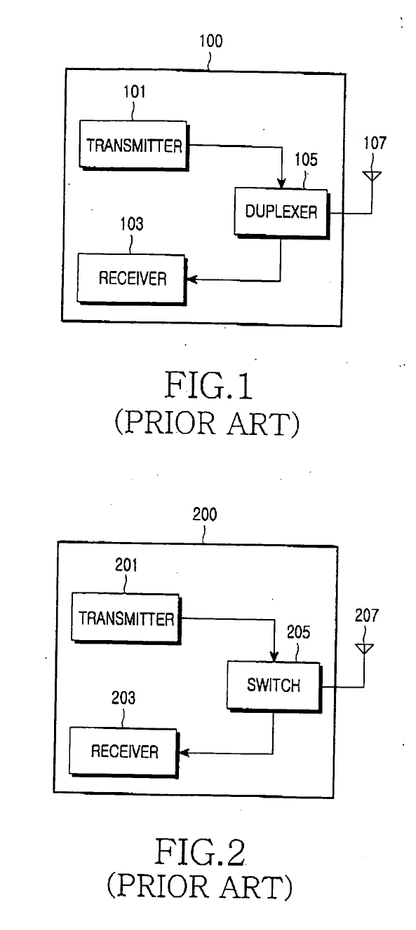

### DETAILED DESCRIPTION OF THE PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Throughout the drawings, the same drawing reference numerals will be understood to refer to the same elements, features and structures. Descriptions of well-known functions and constructions are omitted for the sake of clarity and conciseness.

Preferred embodiments of the present invention provide an Space time duplexing (SDD) scheme in a wireless communication system. Particularly, the SDD scheme is implemented using a transmit antenna for sending a signal and a receive antenna for receiving a signal. Thus, the present invention provide a method of transmitting and receiving signals through a transmit antenna and a receive antenna by spatial division.

The present invention will be described in the context of communications between an SDD-based Base Station (BS) and an Mobile Station (MS) in a wireless communication system, by way of example. The present invention can be extended to a communication device such as a BS or MS that has a transmit antenna and a receive antenna for distinguishing transmission from reception during communications.

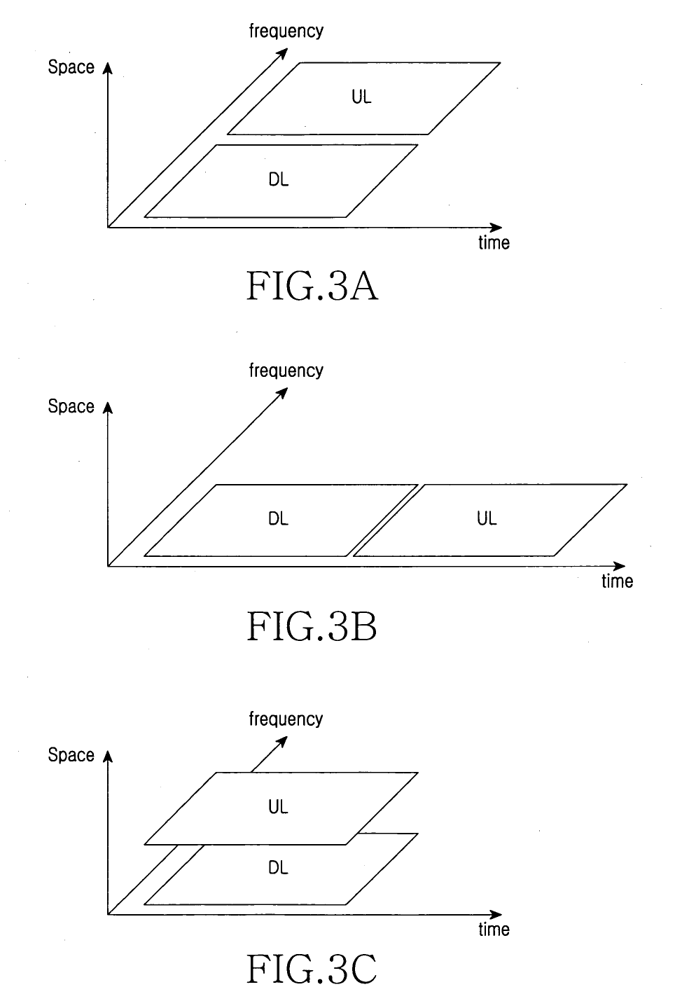

FIGS. 3A, 3B and 3C illustrate Frequency Division Duplexing (FDD) resource allocation, Time Division Duplexing (TDD) resource allocation, and SDD resource allocation according to the present invention, respectively.

The BS defines a transmission link and a reception link, for example, a DownLink (DL) and an UpLink (UL) in frequency, time, or space depending on the duplexing scheme used. The BS separates the transmission link from the reception link on a frequency axis in FIG. 3A and on a time axis in FIG. 3B.

In FIG. 3C, the BS separates the transmission link from the reception link on a spatial axis according to the present invention. In view of the spatial division between transmission and reception, SDD avoids the problems encountered with TDD and FDD. For SDD implementation, the present invention uses a transmit antenna and a receive antenna for separate signal transmission and reception.

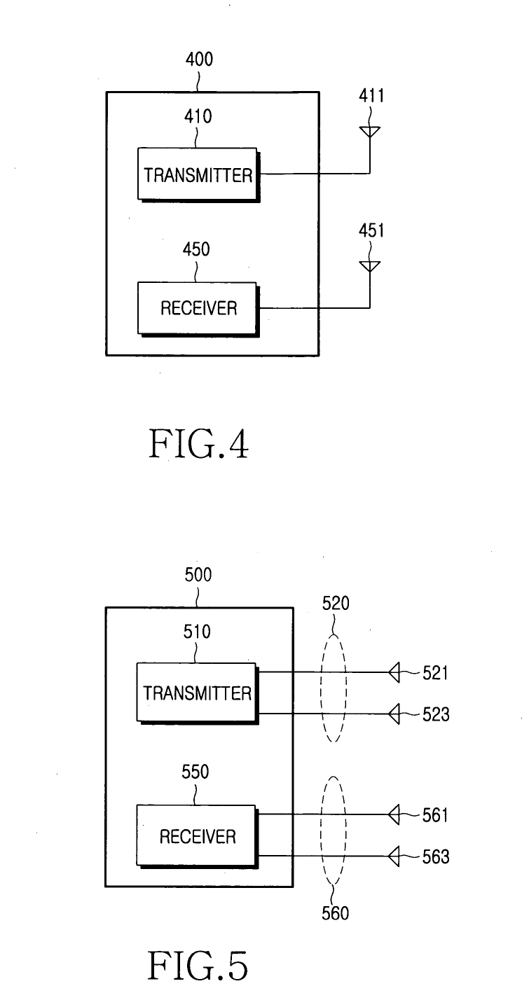

FIG. 4 illustrates the structure of an SDD-based BS in a wireless communication system according to the present invention.

Referring to FIG. 4, a BS 400 includes a transmitter 410, a receiver 450, a first antenna 411 and a second antenna 451. The transmitter 410 processes a signal inside the BS 400 and transmits the signal to an MS through the first antenna 411. The receiver 450 receives a signal through the second antenna 451 and processes the received signal.

The transmitter 410 and the receiver 450 operate independently of each other, which obviates the need for separating transmission from reception either in time or in frequency. Hence, the transmitter 410 and the receiver 450 can continue transmitting and receiving signals without interruptions through the first and second antennas 411 and 451, respectively.

That is, the first antenna 411 is dedicated to signal transmission from the BS 400 and the second antenna 451 is dedicated to signal reception in the BS 400. The use of these antennas 411 and 451 enables signal transmission and reception in spatial division. As a consequence, the BS 400 improves signal transmission efficiency in terms of time resources relative to TDD and frequency resources relative to FDD.

While the BS 400 uses a single transmit antenna and a single receive antenna in FIG. 4, for signal transmission and reception by spatial division, i.e. SDD implementation, it can be further contemplated that the transmitter 400 uses at least two transmit antennas and at least two receive antennas.

FIG. 5 illustrates the structure of an SDD-based BS according to the present invention.

Referring to FIG. 5, a BS 500 includes a transmitter 510, a receiver 550, and first to fourth antennas 521, 523, 561 and 563. The transmitter 510 processes transmission signals inside the BS 500 and transmits signals to MSs through the first and second antennas 521 and 523. The receiver 550 receives signals through the third and fourth antennas 561 and 563 and processes the received signals.

As described above, the BS 500 is provided with at least one antenna for each of transmission and reception. The first and second antennas 521 and 523 form a first antenna group 520 connected to the transmitter 510, and the third and fourth antennas 561 and 563 form a second antenna group 560 connected to the receiver 550.

The first antenna group 510 is dedicated to signal transmission from the BS 500 and the second antenna group 560 is dedicated to signal reception in the BS 500. As with the BS 400 illustrated in FIG. 4, the BS 500 can send and receive signals by spatial division, i.e. in SDD.

Two antennas are applied to each of the transmitter 510 and the receiver 550. Thus, the first and second antenna groups 520 and 530 each can include at least one antenna. Therefore, the first antenna group 520 and the second antenna group 530 each may have the same or a different number of antennas.

When a transmit antenna and a receive antenna are used separately as illustrated in FIGS. 4 and 5, a transmission signal directed to the transmit antenna may be introduced into the receive antenna in the BS, thus acting as noise and decreasing signal reception performance. Antenna configurations for preventing the introduction of the transmission signal into the receive antenna will be described below.

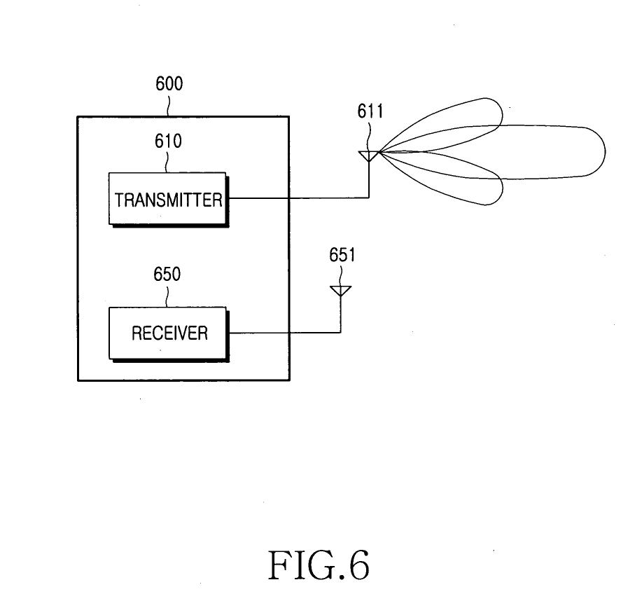

FIG. 6 illustrates an antenna configuration for SDD implementation in the wireless communication system according to a first embodiment of the present invention.

Referring to FIG. 6, a BS 600 includes a transmitter 610, a receiver 650, a first antenna 611 and a second antenna 651. The transmitter 610 processes a transmission signal inside the BS 600 and sends the transmission signal to an MS through the first antenna 611. The receiver 650 receives a signal through the second antenna 651 and processes the received signal. As described above, the BS 600 operates in SDD and the transmitter 610 and the receiver 650 send and receive signals through the first and second antennas 611 and 651 by spatial division.

The second antenna 651 receives a signal from an MS within the coverage area of the BS 600. To prevent the introduction of the transmission signal of the BS 600 to the second antenna 651, a directional antenna with directionality in one direction is used as the first antenna 611. In this case, the second antenna 651 is located behind the first antenna 611 in the direction of the first antenna 611, to thereby limit the introduction of the transmission signal to the second antenna 651.

In this manner, interference between the transmit antenna and the receiver antenna can be prevented by the use of a directional antenna and the positioning of the transmit antenna before the receive antenna.

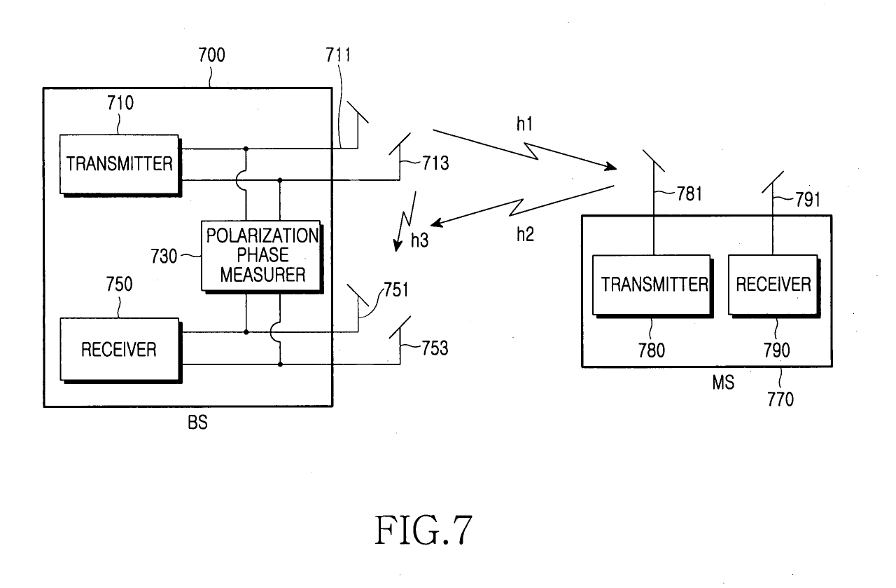

FIG. 7 illustrates an antenna configuration for SDD implementation in the wireless communication system according to a second embodiment of the present invention.

Referring to FIG. 7, a BS 700 includes a transmitter 710, a receiver 750, a polarization phase measurer 730, and first to fourth antennas 711, 713, 751 and 753. An MS 770 includes a transmitter 780, a receiver 790, a fifth antenna 781 and a sixth antenna 791.

The BS 700, which operates in SDD, sends signals through the first and second antennas 711 and 713 and receives signals through the third and fourth antennas 751 and 753. The MS 770 also operates in SDD. It sends a signal to the BS 700 through the fifth antenna 781 and receives a signal from the BS 700 through the sixth antenna 790.

The first to sixth antennas 711 to 791 are all polarization antennas. The polarization antennas utilize polarization in signal transmission and reception. Signals are sent and received by adjusting a polarization phase between a transmit polarization antenna and a receive polarization antenna.

In the BS 700, the polarization phase measurer 730 analyzes signals received through the third and fourth antennas 751 and 753 and measures the phases of the received signals. Then the polarization phase measurer 730 controls the phases of transmission signals from the transmitter 710 to be orthogonal to the phase measurements.

The MS 770 communicates with the BS 700 through the fifth and sixth antennas 781 and 791 designed to have polarizations orthogonal to each other. That is, the transmit antenna has a polarization orthogonal to that of the receive antenna.

The BS 700 measures the polarization phase of a signal received on a channel h2 by means of the polarization phase measurer 730 and sends a signal with a polarization phase orthogonal to the measured polarization phase on a channel h3. Because the signals with mutually orthogonal polarization phases do not affect each other, interference from the channel h3 is reduced.

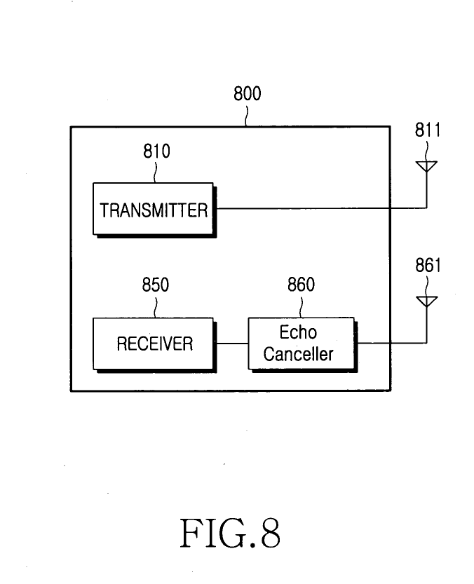

FIG. 8 illustrates an antenna configuration for SDD implementation in the wireless communication system according to a third embodiment of the present invention.

Referring to FIG. 8, a BS includes a transmitter 810, a receiver 850, a first antenna 811, a second antenna 861 and an echo canceller 860. The BS 800 operates in SDD. The transmitter 810 sends a signal to an MS through the first antenna 811 and the receiver 850 receives a signal through the second antenna 861.

The echo canceller 860 receives the transmission signal to be transmitted through the first antenna 811 and eliminates the transmission signal from the signal received through the second antenna 861, thus canceling interference caused by the transmission signal.

The antenna configurations for an SDD-based BS according to the present invention have been described with reference to FIGS. 6, 7 and 8. Depending on system situation or system characteristics, each of the antenna configurations may be used alone or in combination with at least one other antenna configuration.

The SDD-based BS communicates with SDD-based MSs each having a transmit antenna and a receive antenna. Also, the SDD-based BS may communicate with TDD-based MSs or FDD-based MSs.

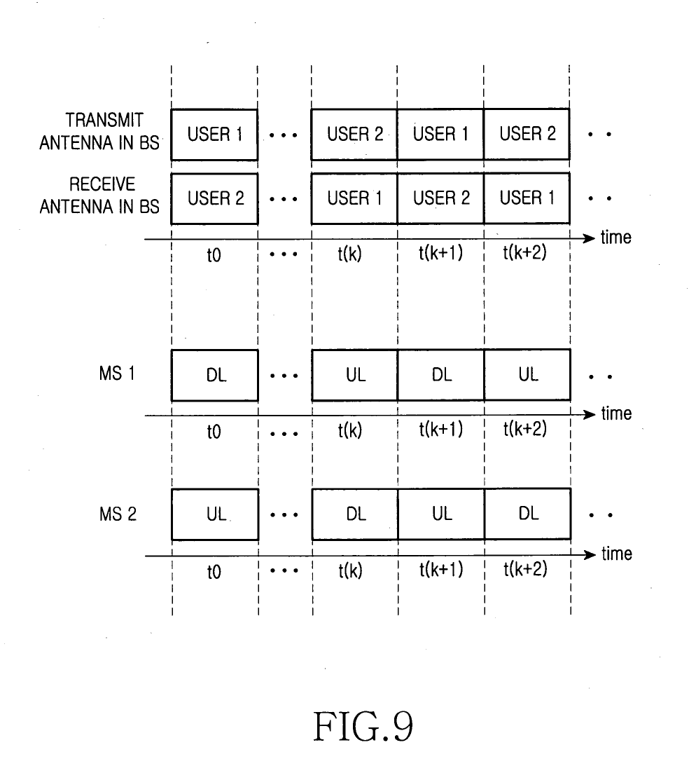

FIG. 9 illustrates signal transmission and reception between a BS and TDD-based MSs according to the present invention.

Referring to FIG. 9, downlink frames and uplink frames between the BS and first and second MSs (MS 1 and MS 2) are shown. The BS operates in SDD according to the present invention.

At time t(0), the transmitter of the BS sends a signal to MS 1 through a transmit antenna and MS 1 receives the signal from the BS on the downlink. Also, MS 1 receives a signal carrying time assignment information from the BS and performs data detection and decoding according to the received signal. Meanwhile, the receiver of the BS receives data from MS 2 through a receive antenna and performs data detection and decoding on the received data. When receiving the signal from MS 2, the BS can implement an antenna technique that cancels interference from the transmission signal sent through the transmit antenna.

At time t(k), the transmitter of the BS sends a signal to MS 2 through the transmit antenna. MS 2 receives the signal from the BS on the downlink and detects and decodes the received signal. Meanwhile, the receiver of the BS receives a signal from MS 1 through the receive antenna, and detects and decodes the received signal.

At time t(k+1), the transmitter of the BS sends a signal to MS 1 through the transmit antenna. MS 1 receives the signal from the BS on the downlink, and detects and decodes the received signal. Meanwhile, the receiver of the BS receives a signal from MS 2 through the receive antenna, and detects and decodes the received signal.

At time t(k+2), the BS operates in the same manner as at time t(k). As described above, MS 1 and MS 2 operate in TDD and the BS operates in SDD. The BS can receive signals from MS 1 and MS 2 alternately in time. The BS alternates between transmission and reception in communicating with MS 1 and MS 2. While two MSs are taken by way of example, the present invention can be extended to more MSs.

When the SDD-based communicates with FDD-based MSs, the above-described method applies to the FDD-based MSs in the same manner, except by frequency rather than by time.

When the BS communicates with MS 1 and MS 2 operating in FDD, it sends signals to MS 1 and MS 2 in 2-predetermined frequency bands through the transmit antenna and receives signals from MS 1 and MS 2 in the 2-predetermined frequency bands which are switched and assigned to MS 1 and MS 2 through the receive antenna.

In other words, in communicating with MS 1 and MS 2, the BS transmits signals to MS 1 through a first frequency band and MS 2 through a second frequency band by dividing the frequency area and receives signals from MS 1 through the second frequency band and MS 2 through the first frequency band in the frequency area. Therefore, transmission frequency area and reception frequency area are shared between MS 1 and MS 2.

As a result, one or more frequency bands in a frequency area can be divided or one or more time period in a time area can be divided to separate each MSs. Also the one or more frequency bands can be shared to transmit and receive between the SDD-based BS and one or more TDD-based/FDD-based MSs.

As described above, the BS has separate transmit and receive antennas. When communicating with TDD-based MSs, the BS carries out transmission and reception independently in time. When communicating with FDD-based MSs, the BS carries out transmission and reception independently in frequency.

In this manner, the SDD-based BS can communicate with TDD-based MSs or FDD-based MSs. The SDD scheme can be extended to a wireless communication system apparatus having a transmitter and a receiver as well as a BS.

As descried above, the present invention advantageously enables signal transmission and reception without dissipation of time and frequency resources by use of an SDD scheme that divides space for communications in a wireless communication system, compared to TDD and FDD schemes. Therefore, the wireless communication system overcomes the aforementioned drawbacks of TDD and FDD.

While the present invention has been shown and described with reference to certain preferred embodiments thereof, it will be understood by those skilled in the art that various changes in form and details may be made therein without departing from the spirit and scope of the present invention as defined by the appended claims and their equivalents.

What is claimed is:

1. An apparatus for transmitting and receiving signals in a wireless communication system having at least two antennas, comprising:
a first antenna for transmitting a transmission signal;
a second antenna for receiving a reception signal;
a transmitter for transmitting the transmission signal through the first antenna; and
a receiver for receiving the reception signal through the second antenna.

2. The apparatus of claim 1, wherein the first antenna is dedicated to signal transmission.

3. The apparatus of claim 1, wherein the second antenna is dedicated to signal reception.

4. The apparatus of claim 1, wherein the apparatus is a Base Station (BS) in the wireless communication system.

5. The apparatus of claim 4, wherein the apparatus communicates with a Mobile Station (MS) having at least one transmit antenna and at least one receive antenna.

6. The apparatus of claim 1, wherein the first antenna and the second antenna share a frequency area for communicating with at least one mobile stations.

7. The apparatus of claim 1, wherein the first antenna transmits downlink signal to a first Mobile Station (MS) and the second antenna receives uplink signal from a second MS in one frequency band at a first time duration.

8. The apparatus of claim 7, wherein the first antenna transmits downlink signal to the second MS and the second antenna receives uplink signal from the first MS in the one frequency band at a second time duration.

9. The apparatus of claim 1, wherein the first antenna transmits downlink signal to a first Mobile Station (MS) and the second antenna receives uplink signal from a second MS in a first frequency band.

10. The apparatus of claim 9, wherein the first antenna transmits downlink signal to the second MS and the second antenna receives the first MS in a second frequency band.

11. The apparatus of claim 1, wherein the first antenna is a directional antenna.

12. The apparatus of claim 1, wherein the second antenna is located behind the first antenna.

13. The apparatus of claim 1, wherein the first and second antennas are polarization antennas.

14. The apparatus of claim 13, further comprising a polarization phase measurer for measuring the polarization phase of the reception signal and controlling the polarization phase of the transmission signal transmitted through the first antenna to be orthogonal to the measured polarization phase.

15. The apparatus of claim 1, further comprising an echo canceller for receiving the transmission signal from the first antenna and eliminating the transmission signal from the reception signal received from the second antenna.

16. The apparatus of claim 1, wherein the transmitter sends, if the apparatus communicates with at least two Time Division Duplexing (TDD) apparatuses, a signal to a first TDD apparatus in a first time area and a signal to a second TDD apparatus in a second time area.

17. The apparatus of claim 16, wherein the receiver receives a signal from the second TDD apparatus in the first time area and a signal from the first TDD apparatus in the second time area.

18. The apparatus of claim 17, wherein the first and second time areas alternate according to transmission and reception of the TDD apparatuses.

19. The apparatus of claim 1, wherein the transmitter sends, if the apparatus communicates with at least two Frequency Division Duplexing (FDD) apparatuses, signals to a first FDD apparatus in a first frequency area and a second FDD apparatus in a second frequency area.

20. The apparatus of claim 19, wherein the receiver receives signals from the first FDD apparatus in the second frequency area and from the second FDD apparatus in the first frequency area.

21. A method of transmitting and receiving signals in a wireless communication system having at least two antennas, comprising:
transmitting a first signal through a first antenna dedicated to signal transmission by a transceiver; and
receiving a second signal through a second antenna dedicated to signal reception by the transceiver.

22. The method of claim 21, wherein the transceiver is a Base Station (BS).

23. The method of claim 21, wherein the transceiver communicates with a second transceiver having at least one transmit antenna and at least one receive antenna.

24. The method of claim 21, wherein the first antenna and the second antenna share a frequency area for communicating with at least one mobile stations.

25. The method of claim 21, wherein the first antenna transmits downlink signal to a first Mobile Station (MS) and the second antenna receives uplink signal from a second MS in one frequency band at a first time duration.

26. The method of claim 25, wherein the first antenna transmits downlink signal to the second MS and the second antenna receives uplink signal from the first MS in the one frequency band at a second time duration.

27. The method of claim 21, wherein the first antenna transmits downlink signal to a first Mobile Station (MS) and the second antenna receives uplink signal from a second MS in a first frequency band.

28. The method of claim 27, wherein the first antenna transmits downlink signal to the second MS and the second antenna receives the first MS in a second frequency band.

29. The method of claim 21, wherein the first antenna is a directional antenna.

30. The method of claim 29, wherein the second antenna is located behind the first antenna.

31. The method of claim 21, wherein the first and second antennas are polarization antennas.

32. The method of claim 31, further comprising:
measuring the polarization phase of the second signal received through the second antenna; and
controlling the polarization phase of the first signal transmitted through the first antenna to be orthogonal to the measured polarization phase.

33. The method of claim 21, further comprising:
receiving the first signal transmitted to the first antenna; and
eliminating the first signal from the second signal received from the second antenna.

34. The method of claim 21, wherein if the transceiver communicates with at least two Time Division Duplexing (TDD) apparatuses,
transmitting the first signal through the first antenna dedicated to signal transmission by a the transceiver further comprises transmitting a signal to a first TDD apparatus in a first time area and a signal to a second TDD apparatus in a second time area by the transceiver, and;
receiving the second signal through the second antenna dedicated to signal reception by the transceiver further comprises receiving a signal from the second TDD apparatus in the first time area and a signal from the first TDD apparatus in the second time area by the transceiver.

35. The method of claim 34, wherein the first and second time areas alternate according to transmission and reception of the TDD apparatuses.

36. The method of claim 21, wherein if the transceiver communicates with at least two Frequency Division Duplexing (FDD) apparatuses,
transmitting the first signal through the first antenna dedicated to signal transmission by the transceiver further comprises transmitting signals to a first FDD apparatus in a first frequency area and to a second FDD apparatus in a second frequency area; and
receiving signals through the second antenna dedicated to signal reception by the transceiver further comprises receiving a signal from the first FDD apparatus in the second frequency area and the second FDD apparatus in the first frequency area.
